(19) United States
(12) Patent Application Publication
(10) Pub. No.: US 2013/0119580 A1
(43) Pub. Date: May 16, 2013

(54) SKATE SHELL

(71) Applicant: Hsin-Chih Yang, Kaohsiung City (TW)

(72) Inventor: Hsin-Chih Yang, Kaohsiung City (TW)

(73) Assignee: SAKURAI SPORTS MFG. CO., LTD., KAOHSIUNG CITY (TW)

(21) Appl. No.: 13/296,290

(22) Filed: Nov. 15, 2011

(51) Int. Cl. B29C 45/14

(52) U.S. Cl. 264/279

(57) ABSTRACT

A method for manufacturing a skate shell has acts of providing an expandable sheet, providing a mold assembly, forming the sheet into a three dimensional shape, mounting the shaped sheet around an inner mold, closing the mold assembly, forcing molten plastic material into the mold assembly and opening the mold assembly. The mold assembly has an outer mold and an inner mold to form a mold cavity. The inner mold has a mold block. The sheet has a peripheral rim squeezed by the inner mold and the outer mold when the mold assembly is closed and the peripheral rim of the sheet is positioned onto the mold block with a positioning assembly. The plastic material is injected into the mold cavity and combined with the shaped sheet to make the sheet smoothly bonded to one surface of the skate shell in a three dimensional arrangement.

### BACKGROUND OF THE INVENTION

1. Field of the Invention

The present invention relates to a method for manufacturing a skate shell, and more particularly to a method for manufacturing a non-lasted skate shell for ice-skates, in-line skates and the like and having a three dimensional sheet arrangement.

2. Description of Related Art

A conventional skate shell for an ice-skate or an in-line skate is made of plastic material with injection molding processes and substantially comprises a toe cap, two lateral vamps, a quarter and a sole.

U.S. Pat. No. 7,712,173, entitled “Method of Manufacturing an Ice Skate” discloses another outer shell having two skirt portions folded inwardly and affixed to each other by stitching or a snap assembly to form a sole. Therefore, the skate shell of the '173 patent has to proceed with combining and lasting/brushing steps after the forming process, so the method of the '173 patent is complicated and time-consuming.

US Patent Publication No. 2010/0275393, entitled “Method of Making a Lasted Skate Boot” discloses an outer shell having two side skirt portions partially extending over and affixed to the insole to form the bottom sole of the body. Therefore, the skate shell of the '393 patent also has to proceed with combining insole, lasting, brushing and outsole assembling steps of the conventional skate lasting processes after the injection molding process, so the method of the '393 patent is also complicated and time-consuming.

In addition, an outsole is necessary with the sole of the shell of the '173 patent and the '393 patent. The shell binds to the outsole through glue and nail tacking. Then a skate blade holder with a skate blade is securely connected to the outsole to form a skate. However, gaps easily forms between the outsole and sole of the shell of the '173 patent and the '393 patent, so the force transmission between the outsole and the skate blade holder is insufficient. Consequently, a user who wears the shells has to push the skates with large force, which makes the conventional skate laborious to use.

In addition, to enhance the structural strength of one part of the conventional skate shell, a fabric sheet is embedded in the part of the conventional skate shell, such as the sole. However, the fabric sheet is mounted in a single part of the conventional skate shell, is arranged substantially in a single surface and cannot be arranged in a three dimensional form on the conventional skate shell. Therefore, to mount a fabric sheet in the conventional skate shell is limited and is not versatile.

To overcome the shortcomings, the present invention intends to provide a method for manufacturing a skate shell to mitigate or obviate the aforementioned problems.

### SUMMARY OF THE INVENTION

An objective of the invention is to provide a method for manufacturing a non-lasted skate shell that has a three dimensional sheet arrangement, is easily fabricated and has a good durability.

The method for manufacturing a skate shell comprises acts of providing an expandable sheet having an expansibility of 0.1 to 10%, providing a mold assembly, forming the sheet into a three dimensional shape, mounting the shaped sheet around an inner mold, closing the mold assembly, forcing molten plastic material into the mold assembly and opening the mold assembly. The sheet is provided with a peripheral rim. In the act of providing a mold assembly, the mold assembly has a combinative outer mold and an inner mold to form a mold cavity between the outer mold and the inner mold. The inner mold has a mold block including a base and a shaping block. The shaping block has a shape corresponding to that of the skate shell. In the act of mounting the shaped sheet around an inner mold, the shaped sheet is mounted around the shaping block and positioned on the base of the mold block on the inner mold with a positioning assembly. In the act of closing the mold assembly, the mold cavity is formed between the inner mold and the outer mold and the peripheral rim of the shaped sheet is squeezed by the inner mold and the outer mold. In the act of forcing molten plastic material into the mold cavity, the plastic material is bonded with the shaped sheet to form a skate shell with the shaped sheet smoothly attached to one surface of a plastic body of the skate shell in a three dimensional arrangement. After the act of opening the mold assembly, the skate shell with the sheet is taken out of the mold assembly.

Additionally, a skate shell for a skate in accordance with the present invention is kept free from a toecap and/or a tongue and has a plastic body and a shaped sheet. The plastic body has an inner surface, an outer surface, a vamp and a sole panel. The shaped sheet is three dimensional and expandable, is bonded on either the inner surface or the outer surface of the plastic body and covers the vamp and the sole panel.

With such an arrangement, because the skate shell is formed as a single part including the sole panel integrally formed with the skate shell, no lasting steps following the injection process are needed and a durable structure of the skate shell is provided.

In addition, because the sole panel is made of rigid thermoplastic or thermosetting plastic material, the durability of the skate shell is increased without mounting an additional outsole. The skate shell produced in accordance with the present invention is sturdier than that of the conventional skate boot that is lasted by providing an outsole attached on the skate boot. The skate shell made under this invention can better transfer power to the blade to get to a player's desired speed than the conventional skate boot does.

Furthermore, with the arrangement of the three dimensional shaped sheet bonded onto the body of the skate shell, the appearance of the skate shell can be improved and versatile and the shaped sheet with no stitching line in ankle/tendon area to make the shaped sheet durable in structural strength.

In accordance with one embodiment, the present invention provides a method for manufacturing a skate. The method comprising providing an expandable sheet having an expansibility of 0.1 to 10%, with the sheet having a peripheral rim defined along an edge of the sheet. The method further comprises providing a mold assembly having a combinative outer mold and an inner mold to form a mold cavity between the outer mold and the inner mold, and the inner mold has a mold block including a base and a shaping block with a shape corresponding to that of the skate shell. The method further comprises forming the sheet into a three-dimensional shape approximating the shape of the shaping block, and mounting the shaped sheet around the shaping block and positioned on the base of the mold block on the inner mold. The method further comprises closing the mold assembly to form the mold cavity between the inner mold and the outer mold and squeezing the peripheral rim of the shaped sheet between the inner mold and the outer mold so that at least a portion of the peripheral rim is not within the mold cavity, and forcing molten plastic material into the mold cavity to make the plastic material combined with the shaped sheet and form a skate shell with the shaped sheet smoothly bonded to one surface of a plastic body of the skate shell in a three dimensional arrangement. Further, the method comprises opening the mold assembly and removing the skate shell with the sheet from the mold assembly.

In some such embodiments, in the act of mounting the shaped sheet around and positioned on the mold block of the inner mold, the mold block of the inner mold is provided with multiple hanging stubs mounted on the base of the mold block and around the mold cavity; the sheet is provided with multiple hanging holes separately defined through the peripheral rim of the sheet; and the shaped sheet is positioned onto the hanging stubs on the inner mold by the hanging holes in the sheet.

In additional embodiments, the expandable sheet has an expansibility of 0.1 to 5%. In further embodiments, the expandable sheet has an expansibility of 0.1 to 3%. In yet further embodiments, the expandable sheet has an expansibility of 0.1 to 2%.

In yet additional embodiments, the sheet is selected from one or more of fabric, textile, natural or artificial leather, synthetic material and composite material. Some such embodiments additionally comprise trimming at least a part of the peripheral rim after removing the skate shell from the mold assembly, and attaching padding elements to the inside of the skate shell. In some embodiments padding elements are attached to a portion of the peripheral rim that was not within the mold cavity during plastic injection.

In some embodiments the peripheral rim is formed as an integral part of the sheet. In other embodiments the peripheral rim is formed as a separate element and is securely mounted on a periphery of the sheet.

In yet additional embodiments, in the act of forming the sheet, a heel element is further attached to a heel segment of the sheet.

In further embodiments, in the act of forcing molten plastic material into the mold cavity, the molten plastic material is injected to urge the shaped sheet to take on the contour of the shaping block of the mold block on the inner mold.

In some such embodiments the expanded sheet is further provided with at least one auxiliary sheet on the expanded sheet to increase the thickness of the sheet on where the at least one auxiliary sheet is mounted, and the thickness of the plastic body corresponding to the at least one auxiliary sheet is correspondingly reduced.

In yet further embodiments, in the act of forcing molten plastic material into the mold cavity, the molten plastic material is injected into and is filled in a gap between the mold block and the shaped sheet so that the shaped sheet is urged against an outer mold surface.

In some such embodiments in the act of forcing molten plastic material into the mold cavity, the shaped sheet is provided with at least one injection hole defined through the shaped sheet, and at least one nozzle is provided on the mold assembly and extends respectively through the at least one injection hole in the shaped sheet when the mold assembly is closed.

In still further embodiments the expanded sheet is further provided with at least one auxiliary sheet on the expanded sheet to increase the thickness of the sheet on where the at least one auxiliary sheet is mounted, and the thickness of the plastic body corresponding to the at least one auxiliary sheet is corresponding reduced.

In some embodiments the peripheral rim is made of a material that is different from the sheet.

In accordance with another embodiment, the present invention provides another method for manufacturing a skate, comprising providing a flat expandable sheet; applying graphics to a first side of the sheet; and forming the sheet into a three dimensional shaped sheet approximating the shape of a foot. The method further comprises providing a mold assembly having an outer mold and an inner mold, the outer and inner molds movable between an open an a closed position, a mold cavity being defined between the molds when in the closed position; placing the shaped sheet over the inner mold; closing the mold; and injecting plastic into the mold cavity so that plastic fills a space between a first mold surface and one of the first or second sides of the shaped sheet, and the other of the first or second sides of the shaped sheet is urged against a second mold surface to form a skate shell.

Some such embodiments additionally comprise providing a positioning assembly, and placing the shaped sheet over the inner mold comprises expanding the sheet and engaging the expanded sheet with the positioning assembly so that the expanded sheet is held in tension over the inner mold. In further embodiments the positioning assembly engages a peripheral of the shaped sheet at a plurality of anchor portions.

In some embodiments the expandable sheet has an expansibility of no more than 10%. In further embodiments the expandable sheet has an expansibility of no more than 5%. In yet further embodiments the expandable sheet has an expansibility of no more than 3%.

In still further embodiments the expandable sheet has an expansibility of no more than 2%.

Additional embodiments comprise providing a plurality of flat expandable sheets. In some such embodiments, forming a three-dimensional shaped sheet comprises attaching the plurality of flat expandable sheets to one another.

In another embodiment, when the expanded sheet is held in tension over the inner mold and the mold is closed, a peripheral rim of the shaped sheet is engaged between mold elements and is not within the mold cavity.

Yet further embodiments comprise removing the skate shell from the mold and trimming off the entire peripheral rim.

Other further embodiments comprise removing the skate shell from the mold and sewing a skate lining to the peripheral rim, which was not within the mold cavity and to which plastic is not bonded. In some such embodiments the shaped sheet engaged the positioning assembly at anchor portions of the peripheral rim, and some embodiments additionally comprise trimming the anchor portions off the peripheral rim after removing the skate shell from the mold.

In yet another embodiment, the plastic is injected adjacent the second side of the shaped sheet, and the first side of the shaped sheet takes on the shape of the outer mold.

In still another embodiment, the plastic is injected adjacent the first side of the shaped sheet, and the second side of the shaped sheet takes on the shape of the inner mold. In one such embodiment the plastic is configured so that the graphics on the first side of the shaped sheet are visible through the plastic after the plastic has cured.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a method for manufacturing a skate shell in accordance with an embodiment of the present invention;

FIG. 2 is an exploded side view of a first embodiment of a sheet for the method in accordance with the present invention;

FIG. 3 is an exploded side view of a second embodiment of a sheet for the method in accordance with the present invention;

FIG. 4 is an operational cross sectional side view of a mold assembly embodiment for the method in accordance with the present invention showing the mold assembly being closed;

FIG. 5 is a perspective view showing the shaped sheet mounted around the shaping block of the mold block of the inner mold;

FIG. 6 is a cross sectional side view of the mold assembly in FIG. 4 showing the mold assembly being closed;

FIG. 6A is an enlarged cross sectional side view of the mold assembly in FIG. 6;

FIG. 6B is another enlarged cross sectional side view of the mold assembly in FIG. 6;

FIG. 7 is a perspective view of a first embodiment of a skate shell with a sheet shown in FIG. 2 bonded onto the inner surface of the skate shell manufactured by the method in accordance with an embodiment of the present invention;

FIG. 8 is a cross sectional side view of the mold assembly in FIG. 4 provided with a nozzle being mounted on the mold assembly;

FIG. 8A is an enlarged cross sectional side view of the mold assembly in FIG. 8;

FIG. 8B is another enlarged cross sectional side view of the mold assembly in FIG. 8;

FIG. 9 is a perspective view of a second embodiment of a skate shell with a sheet shown in FIG. 2 bonded onto the outer surface of the skate shell manufactured by the method in accordance with the present invention;

FIG. 10 is a perspective view of a third embodiment of a skate shell with a sheet shown in FIG. 3 bonded onto the outer surface of the skate shell manufactured by the method in accordance with the present invention;

FIG. 11 is an exploded perspective view of an ice skate having a skate shell manufactured by the method in accordance with the present invention;

FIG. 12 is a perspective view of a fourth embodiment of a skate shell with a sheet composed of multiple sheet pieces bonded onto the outer surface of the skate shell manufactured by the method in accordance with the present invention;

FIG. 13 is an operational cross sectional side view of another embodiment of a mold assembly for the method in accordance with the present invention;

FIG. 13A is an enlarged cross sectional side view of the mold assembly in FIG. 13;

FIG. 14 is an exploded side view of a third embodiment of a sheet for the method in accordance with the present invention;

FIG. 15 is an enlarged cross sectional side view of the sheet along line 15-15 in FIG. 14;

FIG. 16 is a perspective view of a fifth embodiment of a skate shell with a sheet shown in FIG. 14 bonded onto the inner surface of the skate shell manufactured by the method in accordance with the present invention; and

FIG. 17 is an enlarged cross sectional side view of the skate shell along line 17-17 in FIG. 16.

### DETAILED DESCRIPTION OF PREFERRED EMBODIMENT

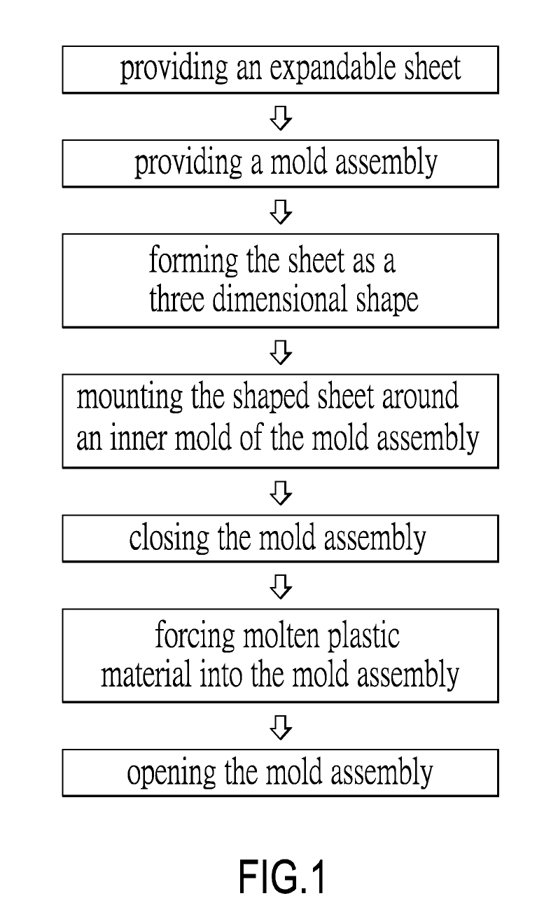

With reference to FIG. 1 a method for manufacturing a skate shell, especially a non-lasted skate shell with a three dimensional sheet arrangement in accordance with the present invention comprises the following acts of providing an expandable sheet, providing a mold assembly, forming the sheet into a three dimensional shaped sheet, mounting the shaped sheet around an inner mold of the mold assembly, closing the mold assembly, forcing molten plastic material into the mold assembly and opening the mold assembly.

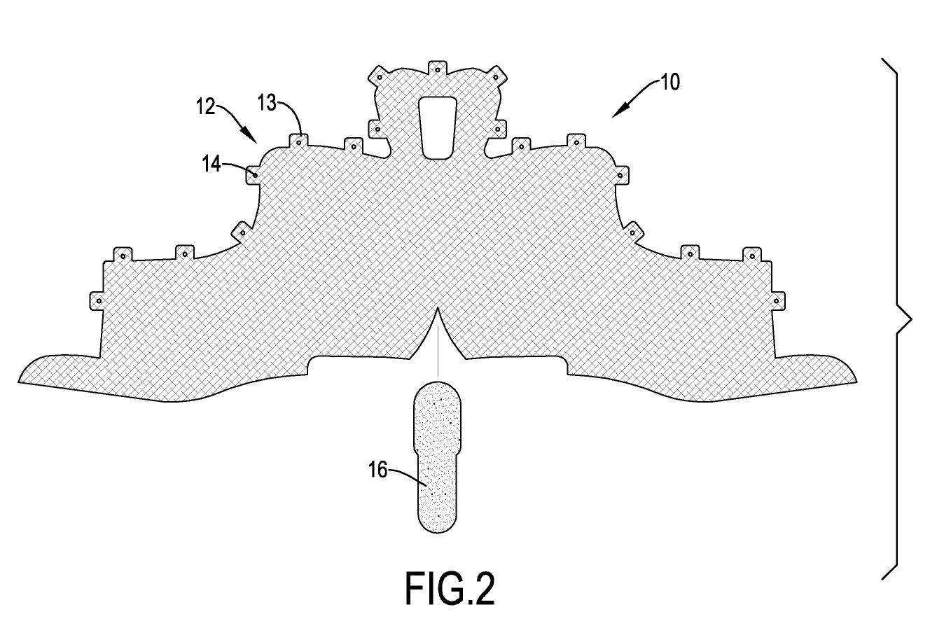

In the act of providing the expandable sheet, with further reference to FIG. 2, the expandable sheet 10 is preferably a flat but flexible sheet made of a material having an expansibility of 0.1 to 10%. The expansibility of 0.1 to 10% means that the sheet 10 may be expanded to 100.1 to 110% in length along a direction or in the whole area of the sheet when a force is applied to the sheet 10. Preferably, the expansibility of the sheet 10 may be 0.1 to 5%, with the expansibility of 0.1 to 3% or 0.1 to 2% most preferred.

The sheet 10 may be fabric, textile, natural or artificial leather, synthetic material, such as Polyurethane (PU) and the like or composite material, such as carbon fiber or fiberglass and the like. The sheet 10 may be composed of one or multiple layers, and may include multiple pieces that are sewn, bonded or otherwise connected to form the sheet 10. In a preferred embodiment, desired graphical features are printed or otherwise applied to the pieces that make up the sheet 10 when the sheet and/or pieces are flat. This may occur before or after the pieces are assembled to form the sheet 10. In one embodiment, after graphical features are applied, and/or after desired visual or tactical treatments have been performed on the pieces, the flat pieces are attached to form the sheet 10, which may take on the shape of a three dimensional shaped sheet 18. In another embodiment, one or more of the pieces may have three-dimensional features before being attached to other pieces. Further, different pieces may have different material properties, such as expandability, thickness, color, porosity or the like.

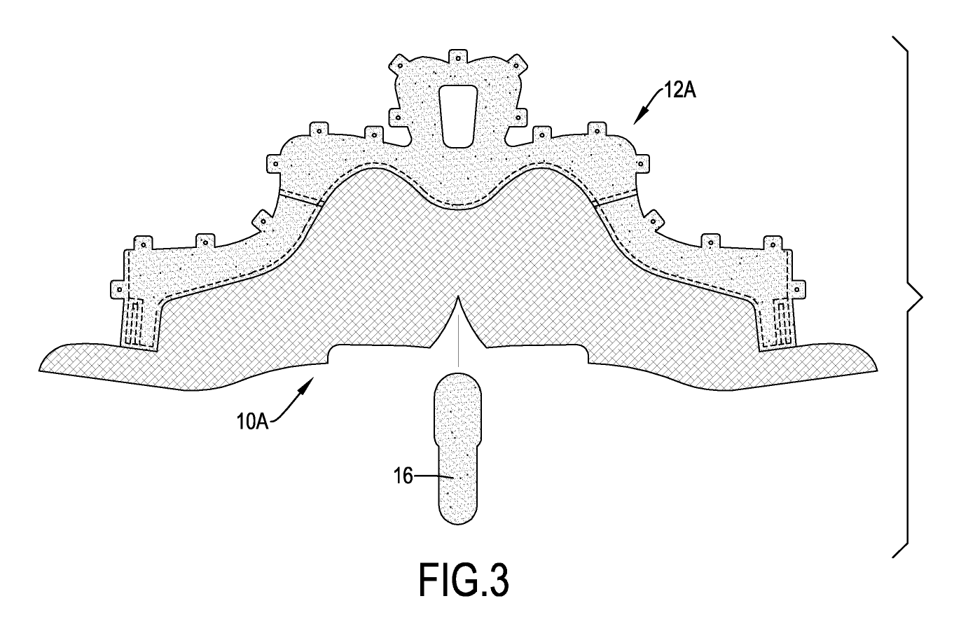

Preferably the sheet 10 has a peripheral rim 12 along an edge. In the illustrated embodiment, the peripheral rim 12 is an integral part of the sheet 10 as shown in FIG. 2. Alternatively, the peripheral rim 12A can be a separately-manufactured element securely mounted on the periphery of the sheet 10A as shown in FIG. 3, and the peripheral rim 12A is made of a material that can be the same or different from the sheet 10A. For example, in one embodiment the sheet 10A is fabric and the peripheral rim 12A is artificial leather. In another embodiment the sheet 10A and peripheral rim 12A are both fabric, but fabric having different properties such as expandability/elasticity, thickness, color, etc. Preferably a plurality of anchor tabs 13 are provided spaced apart along the peripheral rim 12,12A. In the illustrated embodiment, each anchor tab 13 has an aperture 14.

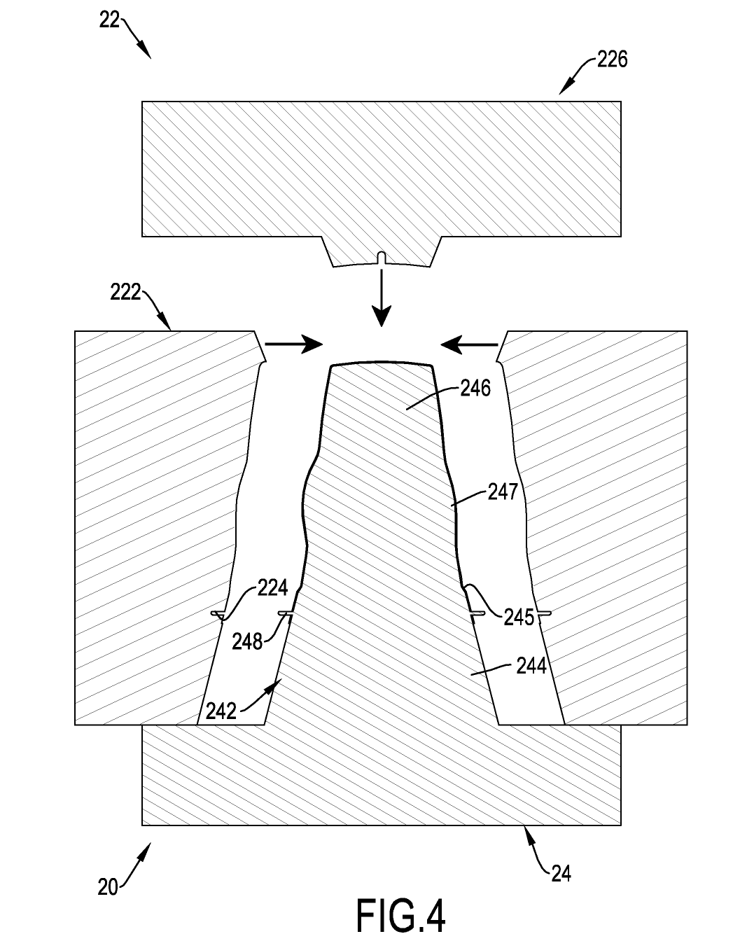

In the act of providing a mold assembly 20, with further reference to FIG. 4, the mold assembly 20 in one embodiment comprises a combinative outer mold 22 and an inner mold 24 configured to form a mold cavity between the outer mold 22 and the inner mold 24 when the mold is in a closed position. The combinative outer mold 22 may comprise two side mold elements 222 and a top mold element 226.

The inner mold 24 is mounted between the side mold elements 222 and the top mold element 226. The side mold elements 222 and the top mold element 226 are moveable to combine with the inner mold 24 to form a mold cavity between the inner mold 24 and the mold elements 222,226 of the outer mold 22.

FIG. 4 includes arrows representing relative movement of portions of the mold embodiment. It is to be understood that these arrows represent relative movement between the elements of the mold, and various specific strategies can be employed for moving the mold portions relative to one another. For example, in one embodiment the inner mold 24 is held stationary and the top mold element 226 moves into engagement with the inner mold 24. In another embodiment the top mold element 226 is stationary and the inner mold 24 moves upwardly into engagement with the top mold element 226. In other embodiments other mold elements, or none of the mold elements, can be held stationary while the other mold elements move relative thereto.

The inner mold 24 has a mold block 242 comprising a base 244 and a shaping block 246. The base 244 is formed on and protrudes from the top of the inner mold 24. The shaping block 246 is formed on and protrudes from the top of the base 244 and has a three dimensional shape corresponding to a desired shape of a completed skate shell which, in a preferred embodiment, generally follows the external anatomical three dimensional shape of a foot.

In some embodiments the shaping block 246 will be contoured to diverge from a foot shape sufficiently to accommodate inserts such as padding, stiffeners and/or vibration-dissipating elements. Preferably, the shaping block 246 has two protrusions 247 formed respectively on two sides of the shaping block 246. The protrusions 247 may be formed on the shaping block 246 at different heights and may protrude from the shaping block 246 in different heights. In the illustrated embodiment the protrusions are shaped to generally follow and accommodate the shapes of human malleolus bones, which it is anticipated will be accommodated within the skate shell.

With continued reference to FIG. 4, the base 244 is larger than the shaping block 246 in cross section area, such that a ledge 245 is formed between the base 244 and the shaping block 246 and around the mold block 242. The ledge 245 has a width corresponding to the desired thickness of the skate shell so that, when the mold is closed the ledge 245 defines a border of the mold cavity. The ledge 245 can be leveled or angled in shape as desired.

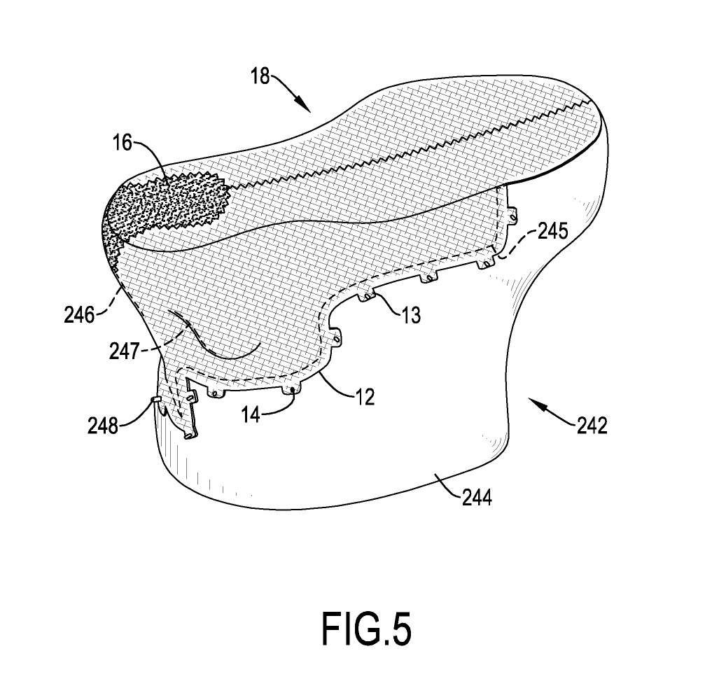

In the act of forming the sheet 10 into a shaped sheet 18, the flat, expanded sheet 10 is formed into a three dimensional shape by sewing, adhering, pressing or otherwise processing to the shape as shown in FIG. 5 and is preferably formed in a shape corresponding to that of the skate shell. More specifically, preferably the shaped sheet 18 includes vamp, quarter, heel and sole panels connected together. In other embodiments the shaped sheet 18 may include more or less panels. For example, in one embodiment the shaped sheet may not include a sole panel.

A heel element 16 as shown in FIGS. 2, 3 and 5 preferably is attached to a heel segment of the shaped sheet 18 to enable the shaped sheet 18 to firmly hold at the three dimensional form and to close holes or notches formed in the shaped sheet 18 due to that the expanded sheet 10,10A is formed into the shaped sheet 18 by sewing or adhering. The heel piece 16 can be made of a material different from that of sheet 10,10A. For example, the heel piece 16 may be thicker, thinner, more or less expandable, or the like, than other portions of the sheet 10.

In the act of mounting the shaped sheet 18 around and positioned on the inner mold 24, with reference to FIGS. 4 and 5, the shaped sheet 18 is mounted around the shaping block 246 and positioned on the base 244 of the mold block 242 on the inner mold 24 with a positioning assembly. In the illustrated embodiment, the positioning assembly comprises multiple hanging stubs 248 configured to engage corresponding hanging holes 14 on the anchor tabs 13. The hanging stubs 248 preferably are mounted on the base 244 of the mold block 242 at positions outside the mold cavity and are arranged around the mold cavity. The hanging holes 14 are separately defined through the peripheral rim 12 of the sheet 10 as shown in FIG. 2.

To position the shaped sheet 18 on the mold block 242 of the inner mold 24, and the shaped sheet 18 is hung onto the hanging stubs 248 by the hanging holes 14. Multiple separate anchor tabs 13 may be formed around the peripheral rim 12, and the hanging holes are defined respectively through the anchor tabs 13. In addition, with the hanging stubs 248 being mounted on positions outside the mold cavity in the illustrated embodiment, the peripheral rim 12 extends out of the mold cavity when the mold assembly 20 is closed. In another embodiment, a portion of the peripheral rim 12 is within the mold cavity when the mold assembly 20 is closed. In a further embodiment, substantially the entire peripheral rim is within the mold cavity when the mold assembly is closed, so that only the anchor tabs 13 extend out of the mold cavity so as to engage the hanging stubs 248. In still other embodiments, both the peripheral rim and the hanging stubs are within the mold cavity when the mold assembly is closed. Such embodiments may employ anchor tabs 13 or may have hanging holes formed through the peripheral rim.

Preferably, engaging the hanging holes 14 onto the stubs 248 holds the shaped sheet 18 in place on the mold block 242. More preferably, with the positioning assembly engaged the shaped sheet 18 is held tightly on the mold block 242 so that the shaped sheet 18 is under tension and is stretched or expanded so as to conform to the mold block shape. For example, mounting the shaped sheet 18 onto the mold block 242 preferably involves stretching/expanding the shaped sheet in order to engage the holes 14 onto the stubs 248. As such, the shaped sheet 18 is held tautly over the mold block 242. Preferably, the tension in the shaped sheet 18 is sufficient so that the sheet will not wrinkle when molten plastic is later injected, but not so taut as to break during the plastic injection process.

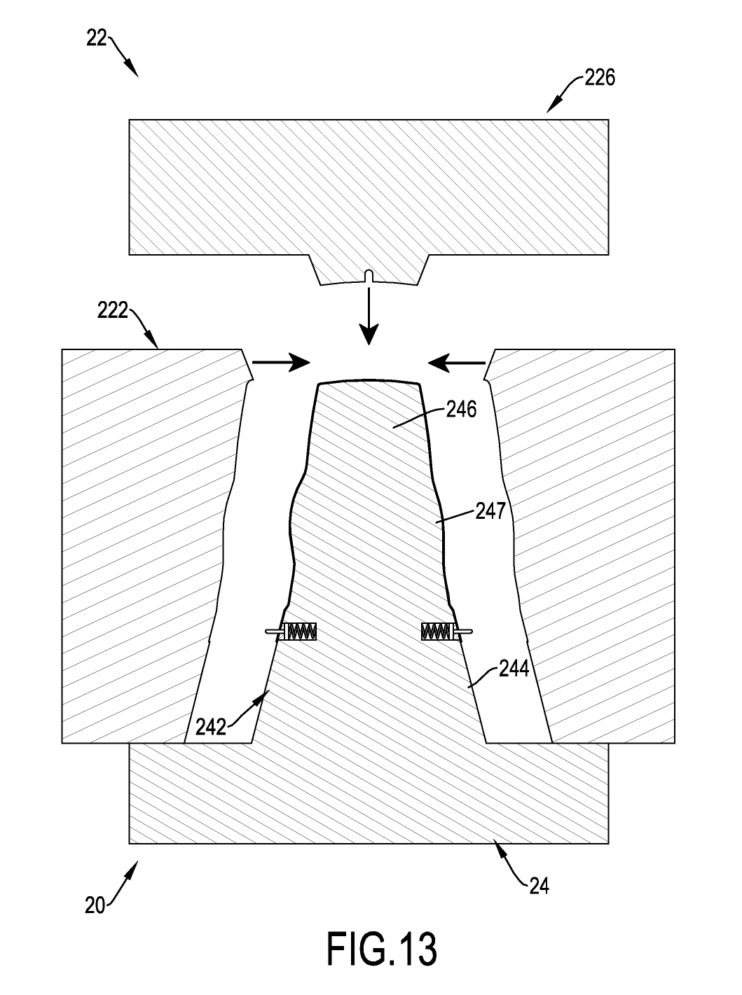

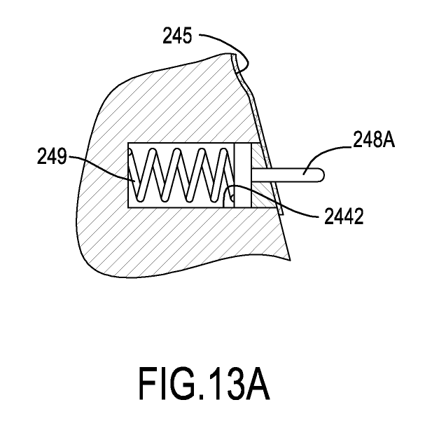

With reference to FIG. 4, the hanging stub 248 is an integral part of the base 244 of the mold block 242. With reference to FIGS. 13 and 13A, in another embodiment the hanging stub 248A is retractably mounted on the base 244 of the mold block 242. In this embodiment, multiple stub holes 2442 are defined in the base 244, and the hanging stubs 248A are mounted respectively in the stub holes 2442 in the base 244. A spring 249 is mounted in each stub hole 2442 and abuts with the corresponding hanging stub 248A to push one end of the hanging stub 248A out of the stub hole 2442 and protrude from the base 244. Consequently, the shaped sheet 18 is also hung onto the hanging stubs 248A by the hanging holes 14.

Alternatively, the positioning assembly may include hooks, clampers or the like to position the rim 12 of the shaped sheet 18 securely on the mold block 242. In further embodiments the shaped sheet 18 may be fit over the mold block 242 without a positioning assembly, and may be held tightly in place when the mold assembly is closed and engages the peripheral rim 12.

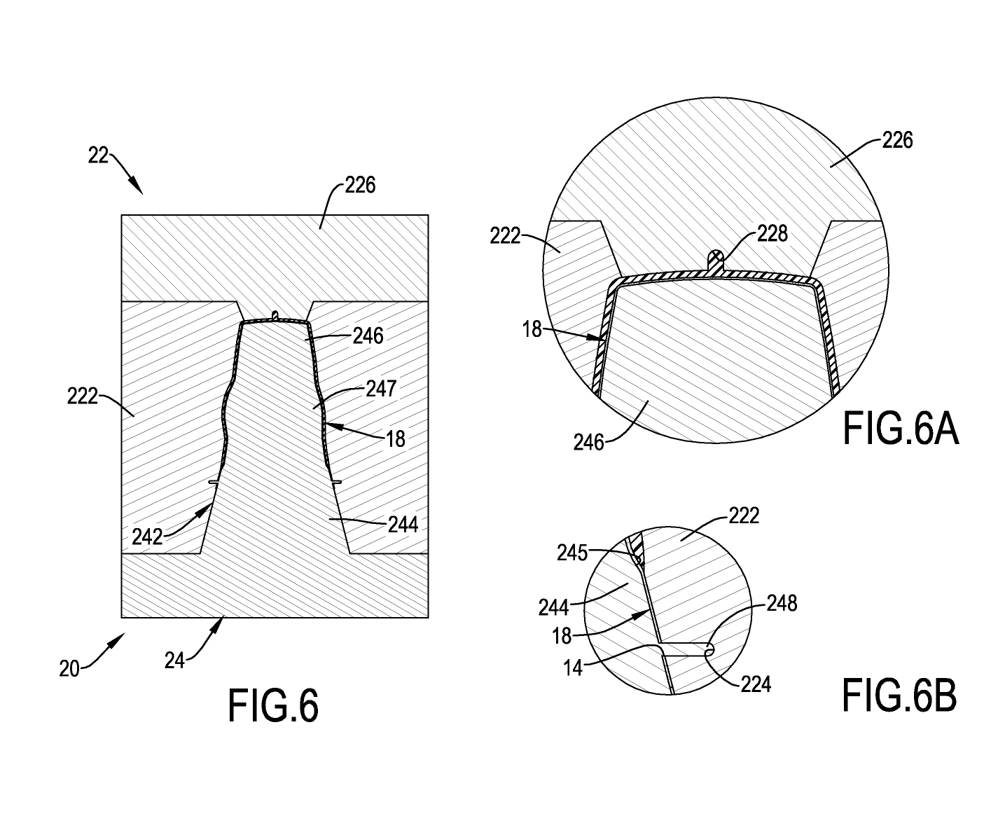

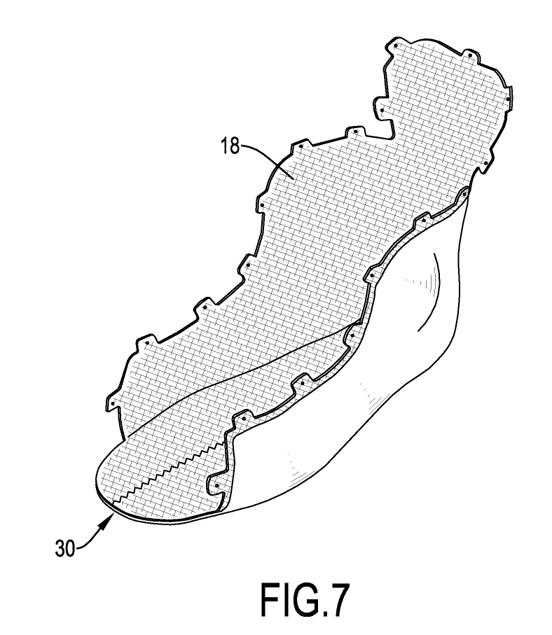

In the act of closing the mold assembly 20, with reference to FIGS. 4, 6, 6A and 6B, the side mold elements 222 and the top mold element 226 of the outer mold 22 are moved toward and combined with the inner mold 24, such that the mold cavity is formed between the inner mold 24 and the outer mold 22 when the mold assembly 20 is closed. The peripheral rim 12 of the shaped sheet 18 is squeezed by the inner mold 24 and the side mold elements 222 of the outer mold 22 below the ledge 245.

In the illustrated embodiment, multiple stub holes 224 are defined in the inner surfaces of the side mold elements 222 of the outer mold 22 and respectively correspond to the hanging stubs 248 on the mold block 242 of the inner mold 24. When the mold assembly 20 is closed, the hanging stubs 248 are respectively inserted into the stub holes 224 in the side mold elements 222 to enable the inner mold 24 and the outer mold 22 to be combined with each other tightly.

In the embodiment shown in FIGS. 13 and 13A, when the mold assembly 20 is closed, the hanging stubs 248A are pushed to retract into the stub holes 2442 in the base 244 by the side mold elements 222 to enable the inner mold 24 and the outer mold 22 to be combined with each other tightly.

Once the shaped sheet 18 is appropriately placed in the mold and the mold closed, molten plastic material is injected into the mold cavity via injection channels 228 defined in the outer mold 22. The molten plastic material may be thermoplastic or thermosetting plastic. The injection channels 228 are preferably defined in the top mold element 226 of the outer mold 22. However, it is to be understood that, in other embodiments, injection channels 228 can be provided in other mold elements such as the side mold elements 222 or even the inner mold 24. In the illustrated embodiment the molten plastic material may be injected to surround the shaped sheet 18 that is mounted around the mold block 242 on the inner mold 24. The molten plastic is injected under pressure and, because the shaped sheet 18 is expandable, the molten plastic will fill the mold cavity around the shaped sheet 18 and urge the sheet even more tightly against the mold block 242 so that the shaped sheet 18 assumes the shape of the mold block 242 and the plastic assumes the shape of the outer mold 22. The molten plastic material cools to form the body of the skate shell 30, and the shaped sheet 18 will be tightly and smoothly bonded to and fused with the inner surface of the body of the skate shell 30 in a three dimensional shape based on the shape of the shaping block 246 of the mold block 242 as shown in FIG. 7.

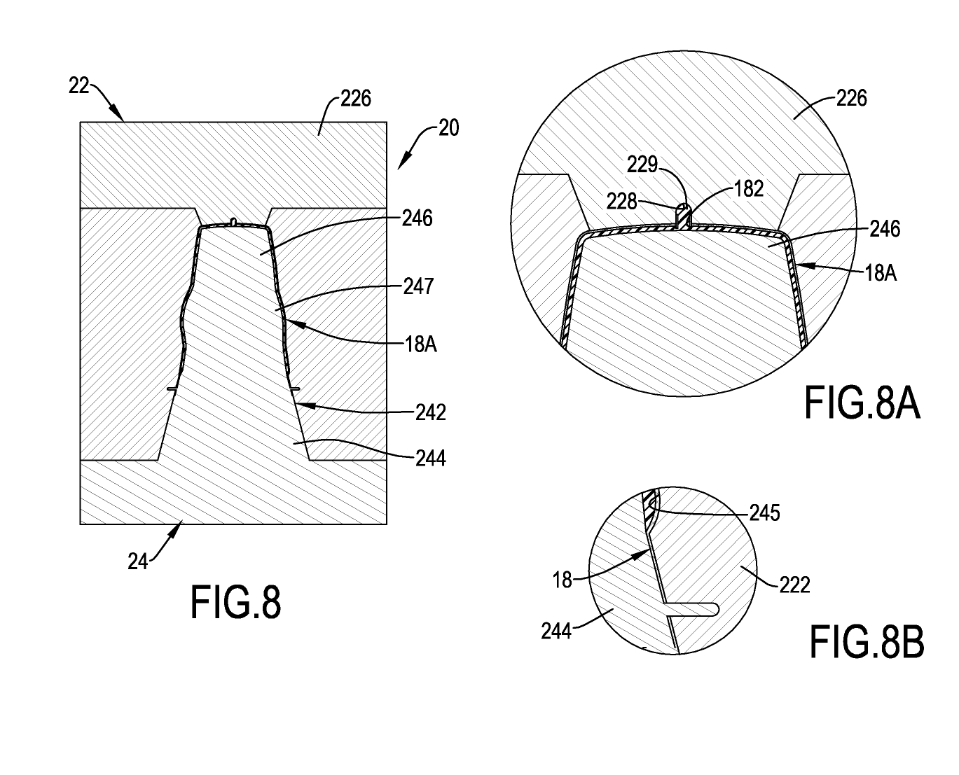

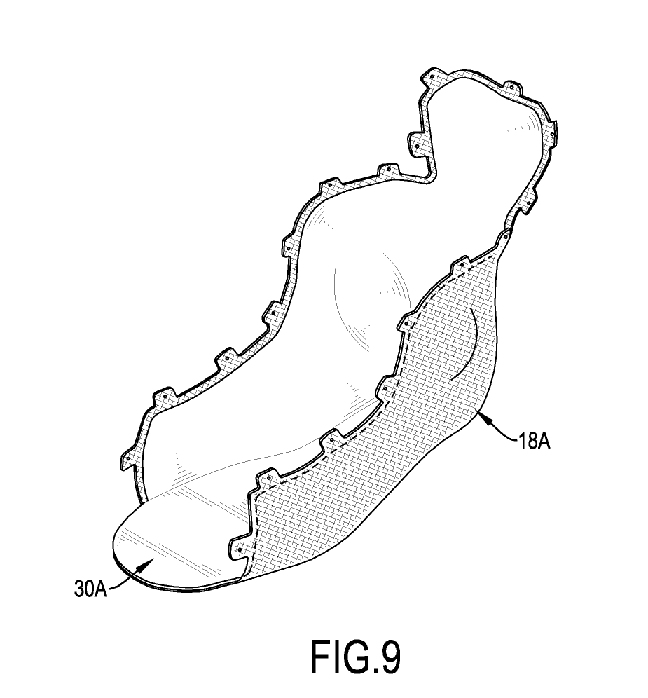

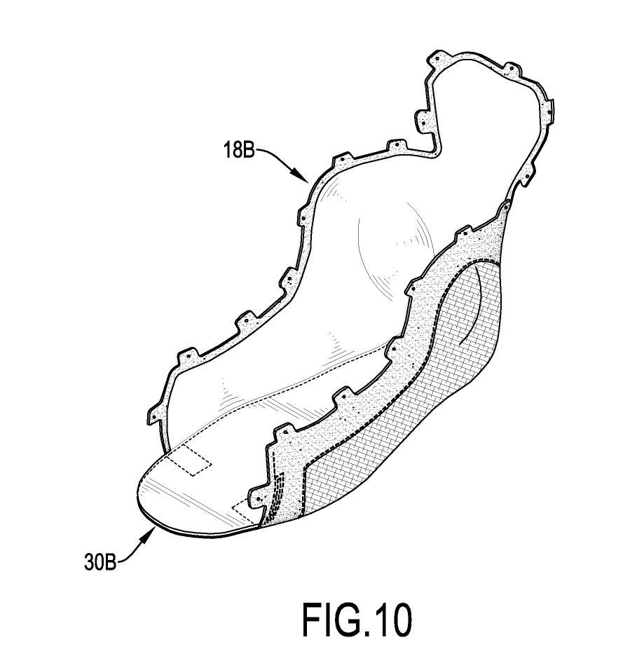

Alternatively, with reference to FIG. 8, the shaped sheet 18A may further have at least one injection hole 182 defined through the shaped sheet 18A, and at least one nozzle 229 is detachably mounted on the mold assembly 20, is preferably detachably inserted into the injection channels 228 in the top mold element 226 of the outer mold 22 and extends respectively through the at least one injection hole 182 in the shaped sheet 18A when the mold assembly 20 is closed. When the molten plastic material is injected into the mold cavity, the molten plastic material will be disposed between the mold block 242 and the shaped sheet 18A. Accordingly, the shaped sheet 18A will be forced against, and take on the shape of, the outer mold 22, and the plastic will take on the shape of the mold block 242 so that the skate shell 30A,30B can be formed between the mold block 242 and the shaped sheet 18A,18B, and the shaped sheet 18A,18B can be expanded tightly by the molten plastic material and securely bonded to the outer surface of the skate shell 30A,30B after the molten plastic material is cooled as shown in FIGS. 9 and 10.

Preferably the nozzle 229 is detachably inserted into the injection channels 228. As such, the same mold assembly 20 can be selectively applied to form a skate shell 30,30A,30B with a shaped sheet 18,18A,18B bonded onto the inner or outer surface of the body of the skate shell 30,30A,30B. Therefore, the mold assembly 20 can be applied to different manufacturing needs and is versatile in use. In additional embodiments, one or more injection channels can be provided through the mold block 242 rather than through the outer mold 22.

As noted above, in some embodiments graphics are applied to the sheet 10 before it is formed into the shaped sheet 18. Thus, in embodiments in which the shaped sheet is molded so as to be on the outer surface of the body of the skate shell, the graphics are already applied, and do not have to be applied to a three dimensional shell. In one embodiment in which the shaped sheet is molded so as to be on the inner surface of the body of the skate shell, the plastic employed can be clear and/or otherwise configured so that graphics on the shaped sheet 18 are visible through the plastic shell.

In still further embodiments, mold pieces can be mixed and matched in order to take the differing manufacturing approaches. For example, in order to form an embodiment in which the plastic shell is on the inside and the shaped sheet is on the outside, a mold block with injection channels may be employed, and molten plastic injected only through the mold block channels. In order to form an embodiment in which the plastic shell is on the outside and the shaped sheet is on the inside, molten plastic will be injected only through injection channels on the outer mold.

Once the plastic has sufficiently cooled, the mold assembly 20 is opened, and the skate shell 30,30A,30B with the shaped sheet 18,18A,18B is taken out of the mold assembly 20.

With the method in accordance with the present invention, a one-piece, three-dimensional and non-lasted skate shell 30,30A,30B can be formed. The skate shell 30,30A,30B comprises a body including a vamp and a sole panel and may, in some embodiments, be kept free from a toecap and/or a tongue. The body of the skate shell 30,30A,30B has an inner surface and an outer surface, and a three dimensional shaped sheet 18,18A,18B is bonded on one of the inner surface and the outer surface of the body and covering completely or partially the vamp and the sole panel. With the protrusions 247 formed on the shaping block 246 of the inner mold 24, the body of the skate shell 30,30A,30B has two ankle bone cavities defined in the vamp to fit with the ankle bones of a user. Accordingly, the skate shell has a contour matching with that of the foot of the user.

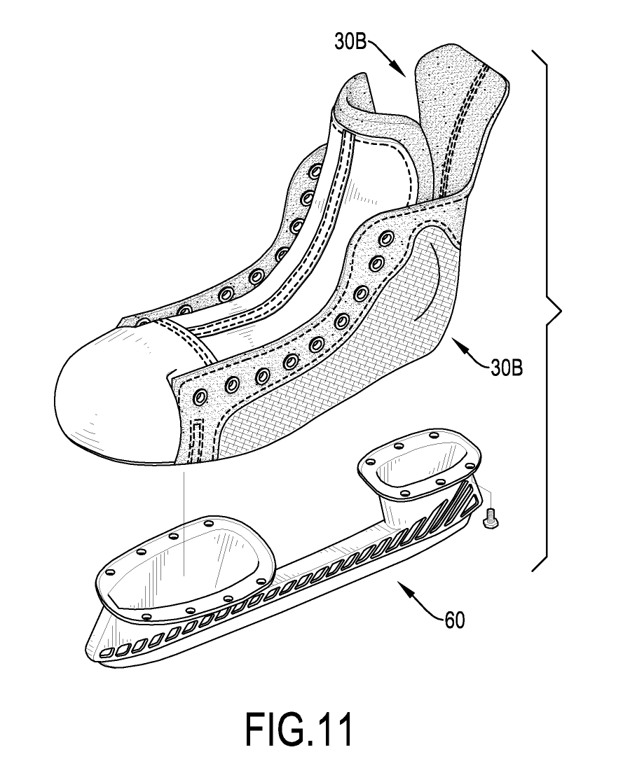

In the illustrated embodiment the skate shell 30,30A,30B is formed as a single structure including the sole panel, and the thickness and/or material of the sole panel can be selected so that the sole panel is rigid enough without requiring additional outsole support to rivet or screw with a skate blade holder 60 as shown in FIG. 11 on the sole panel, the durability of the skate shell 30,30A,30B is increased. Consequently, the force a user applies to move the skates can be more efficiently transmitted from the skate shell 30,30A,30B to the skate blade holder 60 without the energy losses common to multipiece constructions. Therefore, the force transmission between the sole panel of the body and the skate blade holder 60 is improved, and a skate with the skate shell 30,30A,30B in accordance with the present invention is laborsaving. In addition, further proceeding steps, such as sewing, adhering or combining the sole of the skate shell, are unnecessary.

After the molding step is complete, preferably the anchor tabs 13 are trimmed off the peripheral rim. As such, in the molded shell, plastic is bonded to one surface of most or all of the shaped sheet 18 except at the peripheral rim. Steps to complete a skate boot are then performed. For example, lace holes are formed through the shell, and the skate shell 30,30A,30B can be combined with the other components of an ice skate or an in-line skate, such as lining, toecap, tongue, additional padding and/or impact absorbing materials, a blade holder 60, chassis, wheels and other elements that are known to those skilled in the art of a footwear directly as shown in FIG. 11. Therefore, the fabrication of an ice skate or an in-line skate can be efficiently simplified, and the cost of the fabrication of a skate can be decreased.

In a preferred embodiment the lining and/or padding and impact absorbing materials are sewn, glued or otherwise attached to the shell at the portion of the peripheral rim to which plastic is not bonded. In further embodiments, the lining may be sewn to the shell at the peripheral rim, where plastic does not interfere with the stitching, and may be attached to other, spaced apart portions of the shell to which plastic is bonded by other attachment means, such as glue.

In another embodiment, lace holes are formed through the peripheral rim, which was not coinjected with the molten plastic. In further embodiments portions of the peripheral rim are trimmed along a trimmed edge, so that the peripheral rim to which plastic is not bonded is retained adjacent a portion of the length of the trimmed edge, and plastic is bonded to the surface of the shaped sheet up to the another portion of the length of the trimmed edge. Further, in additional embodiments some lace holes are formed through the shell, and other lace holes are formed through a portion of the rim that was not coinjected with the plastic. In still further embodiments the entire peripheral rim is trimmed off after molding is complete so that plastic is bonded to the surface of the shaped sheet up to the trimmed edge.

In addition, because the sheet 18,18A,18B can be tightly and smoothly bonded with the body of the skate shell 30,30A,30B along the surfaces of the skate shell 30,30A,30B, the sheet 18,18A,18B is bonded onto the body of the skate shell 30,30A,30B in a three dimensional arrangement instead of only limited to a single surface arrangement. Therefore, the appearance of the skate shell can be improved and versatile. In addition, the sheet 18,18A,18B can be arranged to completely cover the sole panel of the skate shell 30,30A,30B as shown in FIGS. 7, 9 and 10. Alternatively, the sheet can be arranged to partially cover the sole panel of the skate shell, especially to cover two side edges of the sole panel of the skate shell. Therefore, the shape and the arrangement of the sheet 18,18A,18B can be varied to fit different design needs.

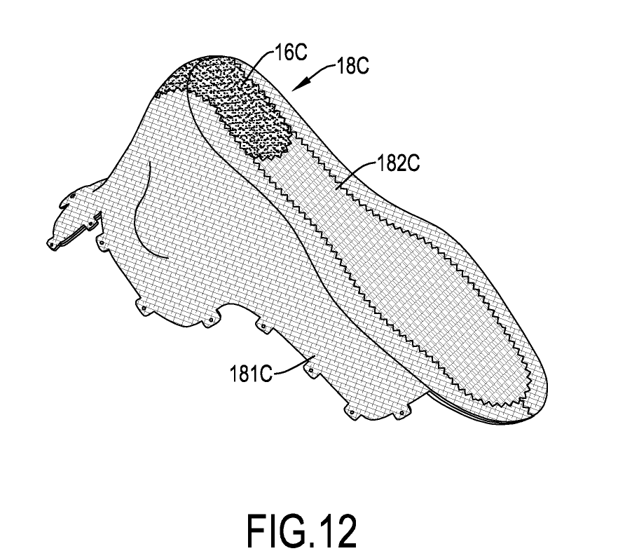

With reference to FIG. 12, the shaped sheet 18C may be composed of three sheet pieces including a vamp sheet piece 181C, a sole piece 182C and a heel piece 16C. The sole piece 182C and the vamp sheet piece 181C may be made of different materials. Preferably, the sole piece 182C has higher expansibility than that of the vamp sheet piece 181C. Preferably, the vamp sheet piece 181C is made of composite material with a low expansibility and the sole piece 182C is made of fabric, textile or leather with a relatively high expansibility. The heel piece 16C can be made of a material different from those for the vamp sheet pieces 181C or the sole piece 182C. Furthermore, a decorative outsole can be attached to the sole panel of the body of the skate shell to improve the aesthetic effect of the skate shell.

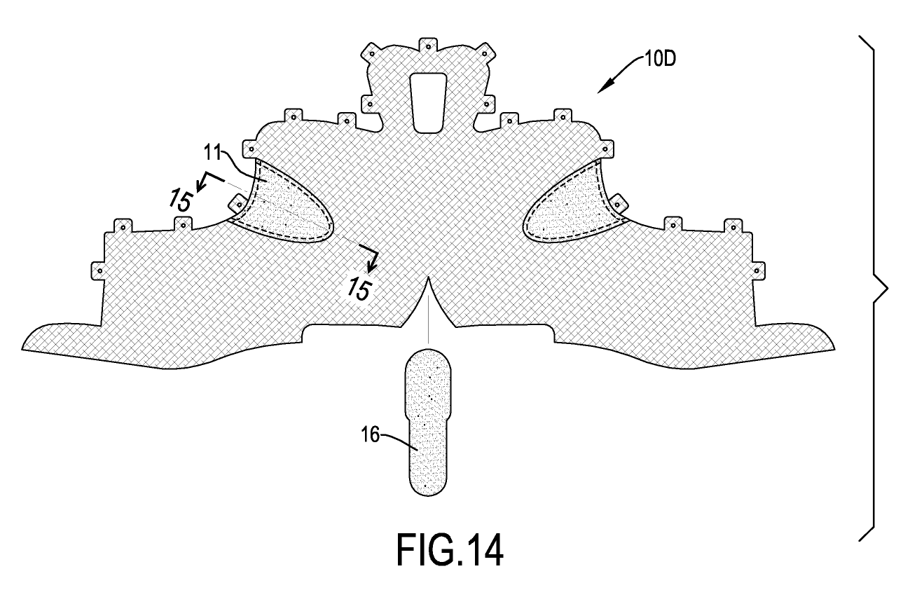

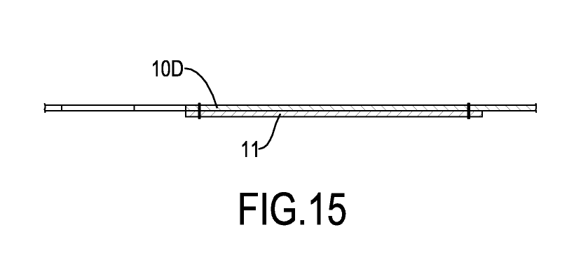

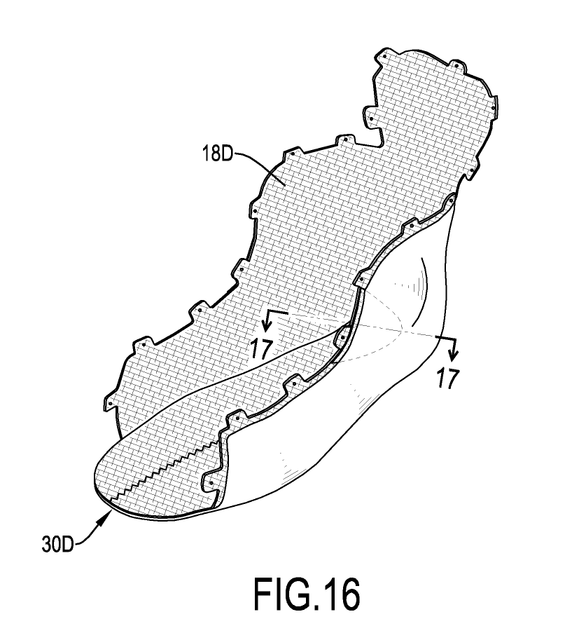

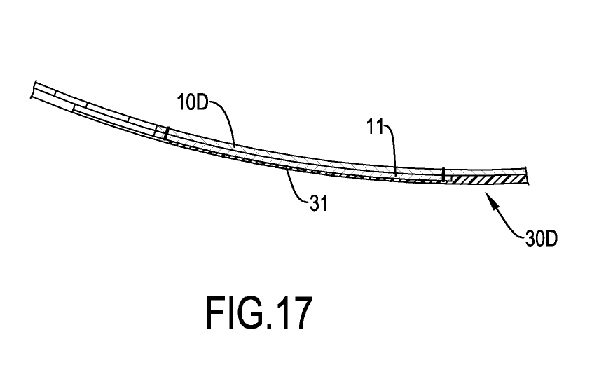

With reference to FIGS. 14 and 15, the sheet 10D may further comprise at least one auxiliary sheet 11 mounted on the sheet 10D. With the arrangement of the auxiliary sheets 11, the thickness of the sheet 10D on the position where the auxiliary sheets 11 are mounted is increased. Accordingly, after the body of the skate shell is formed, with reference to FIGS. 16 and 17, the thickness of the injected thermoplastic/thermosetting plastic body in the area 31 where the auxiliary sheets 11 and the sheet 10 are both presented is reduced. This reduced thickness gives the aforementioned area 31 of the skate shell higher flexibility than those other segments of the body of the skate shell 30D. Therefore, the body of the skate shell has different pliancy in different areas to accommodate the designs or needs for a skate.

In another embodiment, the mold cavity can be provided with different thicknesses on positions corresponding to different segments of the plastic body of the skate shell 30 to fit different skate shell performance design needs. For example, rather than or in addition to having a thicker sheet as shown in connection with the embodiment illustrated in FIGS. 14-15, the mold cavity can be shaped so as to have reduced thickness in the desired area, thus leading to a skate shell that is more flexible in the thin area than elsewhere in the shell. In still further embodiments the mold can be configured to create shapes conducive to selective bending. For example, the ankle area employing the auxiliary sheet 11 in FIG. 14 can also, or instead, be configured so that the molten plastic is formed into a shape having multiple elongate ribs that cooperate to accommodate bending in a desired direction, but resist bending in other directions. Such structures can be incorporated into the mold shape, so that the resultant shell may include shapes that structurally enhance performance or, in other embodiments, provide desired decorative features. In another embodiment, a second mold is provided, and injection-molding of the sheet involves a second plastic injection process. For example, plastic having a first set of properties is injected in the first mold. The sheet is then removed and placed in the second mold for a second injection of plastic having a second set of properties. As such, properties of the shell such as localized areas of changing thickness, flexibility, color and the like can be constructed. Further embodiments may include still further injection processes.

Additionally, in other embodiments the shaped sheet 18 can have inserts attached thereto. Such inserts may be made of plastic, metal, etc., and cooperate with the mold cavity to create a shell having desired structural and graphical properties. Similarly, it is contemplated that in other embodiments the mold cavity can be configured so that no plastic is injected against some portions of the shaped sheet 18.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, Applicants contemplate that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. A method for manufacturing a skate, comprising:
providing an expandable sheet having an expansibility of 0.1 to 10%, the sheet having a peripheral rim defined along an edge of the sheet;
providing a mold assembly having a combinative outer mold and an inner mold to form a mold cavity between the outer mold and the inner mold, and the inner mold having a mold block including a base and a shaping block with a shape corresponding to that of the skate shell;
forming the sheet into a three dimensional shape approximating the shape of the shaping block;
mounting the shaped sheet around the shaping block and positioned on the base of the mold block on the inner mold;
closing the mold assembly to form the mold cavity between the inner mold and the outer mold and squeezing the peripheral rim of the shaped sheet between the inner mold and the outer mold so that at least a portion of the peripheral rim is not within the mold cavity;
forcing molten plastic material into the mold cavity to make the plastic material combined with the shaped sheet and form a skate shell with the shaped sheet smoothly bonded to one surface of a plastic body of the skate shell in a three dimensional arrangement; and
opening the mold assembly and removing the skate shell with the sheet from the mold assembly.

2. The method as claimed in claim 1, wherein in the act of mounting the shaped sheet around and positioned on the mold block of the inner mold,
the mold block of the inner mold is provided with multiple hanging stubs mounted on the base of the mold block and around the mold cavity;
the sheet is provided with multiple hanging holes separately defined through the peripheral rim of the sheet; and
the shaped sheet is positioned onto the hanging stubs on the inner mold by the hanging holes in the sheet.

3. The method as claimed in claim 2, wherein the expandable sheet having an expansibility of 0.1 to 3%.

4. The method as claimed in claim 3, wherein the expandable sheet having an expansibility of 0.1 to 2%.

5. The method as claimed in claim 1, wherein the sheet is selected from one or more of fabric, textile, natural or artificial leather, synthetic material and composite material.

6. The method as claimed in claim 5, additionally comprising trimming at least a part of the peripheral rim after removing the skate shell from the mold assembly, and attaching padding elements to the inside of the skate shell.

7. The method as claimed in claim 6, wherein the peripheral rim is formed as an integral part of the sheet.

8. The method as claimed in claim 6, wherein the peripheral rim is formed as a separate element and is securely mounted on a periphery of the sheet.

9. The method as claimed in claim 1, wherein in the act of forcing molten plastic material into the mold cavity, the molten plastic material is injected to urge the shaped sheet to take on the contour of the shaping block of the mold block on the inner mold.

10. The method as claimed in claim 9, wherein the expanded sheet is further provided with at least one auxiliary sheet on the expanded sheet to increase the thickness of the sheet on where the at least one auxiliary sheet is mounted, and the thickness of the plastic body corresponding to the at least one auxiliary sheet is correspondingly reduced.

11. The method as claimed in claim 1, wherein in the act of forcing molten plastic material into the mold cavity, the molten plastic material is injected into and is filled in a gap between the mold block and the shaped sheet so that the shaped sheet is urged against an outer mold surface.

12. The method as claimed in claim 11, wherein in the act of forcing molten plastic material into the mold cavity, the shaped sheet is provided with at least one injection hole defined through the shaped sheet, and at least one nozzle is provided on the mold assembly and extends respectively through the at least one injection hole in the shaped sheet when the mold assembly is closed.

13. A method for manufacturing a skate, comprising:
providing a flat expandable sheet;
applying graphics to a first side of the sheet;
forming the sheet into a three dimensional shaped sheet approximating the shape of a foot;
providing a mold assembly having an outer mold and an inner mold, the outer and inner molds movable between an open an a closed position, a mold cavity being defined between the molds when in the closed position;
placing the shaped sheet over the inner mold;
closing the mold; and
injecting plastic into the mold cavity so that plastic fills a space between a first mold surface and one of the first or second sides of the shaped sheet, and the other of the first and second sides of the shaped sheet is urged against a second mold surface to form a skate shell.

14. A method as in claim 13 additionally comprising providing a positioning assembly, and placing the shaped sheet over the inner mold comprises expanding the sheet and engaging the expanded sheet with the positioning assembly so that the expanded sheet is held in tension over the inner mold.

15. A method as in claim 14, wherein the expandable sheet has an expansibility of no more than 3%.

16. A method as in claim 14, comprising providing a plurality of flat expandable sheets, and wherein forming a three-dimensional shaped sheet comprises attaching the plurality of flat expandable sheets to one another.

17. A method as in claim 14, wherein when the expanded sheet is held in tension over the inner mold and the mold is closed, a peripheral rim of the shaped sheet is engaged between mold elements and is not within the mold cavity.

18. A method as in claim 17 additionally comprising removing the skate shell from the mold and trimming off the entire peripheral rim.

19. A method as in claim 17 additionally comprising removing the skate shell from the mold and sewing a skate lining to the peripheral rim, which was not within the mold cavity and to which plastic is not bonded.

20. A method as in claim 19, wherein the shaped sheet engaged the positioning assembly at anchor portions of the peripheral rim, and additionally comprising trimming the anchor portions off the peripheral rim after removing the skate shell from the mold.

21. A method as in claim 13, wherein the plastic is injected adjacent the second side of the shaped sheet, and the first side of the shaped sheet takes on the shape of the outer mold.

22. A method as in claim 13, wherein the plastic is injected adjacent the first side of the shaped sheet, and the second side of the shaped sheet takes on the shape of the inner mold.

23. A method as in claim 22, wherein the plastic is configured so that the graphics on the first side of the shaped sheet are visible through the plastic after the plastic has cured.
